(19) United States
(12) Patent Application Publication
(10) Pub. No.: US 2018/0187025 A1
(43) Pub. Date: Jul. 5, 2018

(54) CONDUCTIVE COATING COMPOSITION, CONDUCTIVE MATERIAL, METHOD FOR MANUFACTURING CONDUCTIVE COATING COMPOSITION, AND METHOD FOR MANUFACTURING CONDUCTIVE MATERIAL

(71) Applicant: Panasonic Intellectual Property Management Co., Ltd., Osaka (JP)

(72) Inventor: Akihiko TADAMASA, Osaka (JP)

(21) Appl. No.: 15/739,733

(22) PCT Filed: Jun. 24, 2016
(86) PCT No.: PCT/JP2016/003050

§ 371 Date: Dec. 24, 2017

(30) Foreign Application Priority Data
Aug. 24, 2015 (JP) 2015-165189

(51) Int. Cl. C09D 5/24; C09D 7/40; C09D 7/20

(52) U.S. Cl. CPC C09D 5/24; C08K 3/18; C09D 7/20; C09D 7/40

(57) ABSTRACT

A conductive coating composition includes graphite intercalation compounds, graphite oxides, a binder, and a dissolving agent. The graphite intercalation compounds are compounds having a sandwich structure where various atoms, molecules, etc., are inserted between layers of graphite, which is a layered material in which carbon hexagonal net planes are laminated in parallel. The binder and the dissolving agent allow the graphite intercalation compounds and the graphite oxides to be bonded. The graphite intercalation compounds and the graphite oxides are chemically bonded.

### TECHNICAL FIELD

The present invention relates to a conductive composite material and particularly to a conductive coating composition, a conductive material, a method for manufacturing the conductive coating composition, and a method for manufacturing the conductive material, in which graphite intercalation compounds are used.

### BACKGROUND ART

With the development of electronics technology, circuits formed by printing a conductive coating have started to be used for signal circuits in printed wiring circuits, etc. Conductive materials used for such a purpose are required to be lightweight and highly conductive. For this reason, graphite intercalation compounds are dispersed in a synthetic resin matrix (for example, see Patent document No. 1).

[Patent document No. 1] JPH5-65366

### DISCLOSURE OF THE INVENTION

### Problem to be Solved by the Invention

One of materials that realize high conductivity is a metal material such as silver. However, the unit price of a metal material is generally high. Therefore, a further improvement in the conductivity is required while using graphite intercalation compounds whose unit price is relatively low.

In this background, a purpose of the present invention is to provide a technology for improving conductivity while preventing an increase in unit price.

### Means to Solve the Problem

A conductive coating composition according to one embodiment of the present invention includes graphite intercalation compounds, graphite oxides, a binder, and a dissolving agent, and the graphite intercalation compounds and the graphite oxides are chemically bonded.

Another embodiment of the present invention relates to a conductive material. The conductive material includes graphite intercalation compounds and graphite oxides, and the graphite intercalation compounds and the graphite oxides are chemically bonded.

Yet another embodiment of the present invention relates to a method for manufacturing a conductive coating composition. This method is a method for manufacturing a conductive coating composition, including: producing a conductive material by mixing graphite intercalation compounds and graphite oxides; reducing the graphite oxides by heating the conductive material; producing a binder solution while agitating and heating a binder and a dissolving agent; and adding the conductive material, in which the graphite oxides have been reduced, in the binder solution, wherein the graphite intercalation compounds and the graphite oxides are chemically bonded.

Yet another embodiment of the present invention relates to a method for manufacturing a conductive material. This is a method for manufacturing a conductive material in which graphite intercalation compounds and graphite oxides are mixed, and the graphite intercalation compounds and the graphite oxides are chemically bonded.

### Advantageous Effects

According to the present invention, conductivity can be improved while preventing an increase in unit price.

### BRIEF DESCRIPTION OF THE DRAWINGS

FIG. 1 is a diagram illustrating the configuration of a conductive coating composition according to an embodiment of the present invention.

### MODE FOR CARRYING OUT THE INVENTION

A brief description of the present invention will be given first before a specific description thereof is given. An embodiment of the present invention relates to a conductive material containing a graphite intercalation compound and to a conductive coating composition for which the conductive material is used. As described above, although a metal material has high conductivity, the unit price of the metal material is high. On the other hand, although the unit price of a carbon material is low, the carbon material has low conductivity. Meanwhile, a graphite intercalation compound has relatively high conductivity while being inexpensive. However, when a carbon material is used to bond graphite intercalation compounds to one another, bond resistance becomes high. Therefore, an improvement in the conductivity of a graphite intercalation compound is required. In the present embodiment, graphite intercalation compounds are bonded to one another by reducing graphite oxides. By such bonding, the bond resistance becomes low, and high conductivity can be obtained.

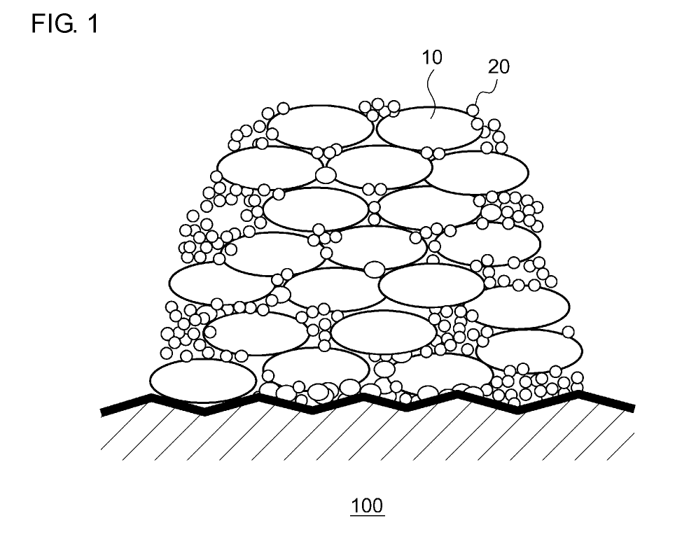

FIG. 1 illustrates the configuration of a conductive coating composition 100 according to the embodiment of the present invention. The conductive coating composition 100 includes graphite intercalation compounds 10 and graphite oxides 20. Further, the conductive coating composition 100 includes a binder and a dissolving agent (not shown) in order for these to be bonded. The graphite intercalation compounds 10 and the graphite oxides 20 are also considered to be conductive materials.

The graphite intercalation compounds 10 are compounds having a sandwich structure where various atoms, molecules, etc., are inserted between layers of graphite, which is a layered material in which carbon hexagonal net planes are laminated in parallel. In the graphite intercalation compounds 10, due to intercalates such as atoms, molecules, etc., that have inserted between layers of graphite and charge transfer occurring between the intercalates and adjacent layers of graphite, the number of conduction carriers on the layers of graphite becomes increased. As a result, the graphite intercalation compounds 10 have high conductivity.

For the graphite intercalation compounds 10, for example, powder of scaly natural graphite, artificial graphite, vapor-grown carbon fibers, graphite fibers, or the like are used as a base material. For the graphite intercalation compounds 10, a pyrolytic graphite sheet obtained by treating a polyimide film with heat at a temperature of 2600 to 3000 degrees Celsius or a pyrolytic graphite sheet that has been ground may also be used as the base material. Further, for the graphite intercalation compounds 10, graphite materials with good crystal integrity such as those carrying a metal at an end portion of these graphite materials may be used as base materials. In order for a metal to be carried at an end portion of a graphite material, for example, a metal complex and a graphite material are mixed and then burned. The base material is not limited to these materials. The surfaces of the graphite intercalation compounds 10 are oxidized.

As the intercalates, all sorts of substance species such as atoms, molecules, ions, etc., can be used, and, for example, metal chlorides, alkali metals, and alkaline earth metals are used. Examples of the metal chlorides include iron chlorides, copper chlorides, nickel chlorides, aluminum chlorides, zinc chlorides, cobalt chlorides, gold chlorides, bismuth chlorides, etc., and examples of the alkali metals and the alkaline earth metals include lithium, potassium, rubidium, cesium, calcium, magnesium, etc. As the intercalates, two or more of these substances may be used in combination. Furthermore, graphite intercalation compounds 10 in which metal chlorides have been inserted may be treated with heat under a stream of hydrogen of 5 to 100 percent and at a temperature of 250 to 500 degrees Celsius, thereby reducing the metal chlorides that have been inserted so that the metal chlorides are present as metal microparticles. When the intercalates inserted inside graphite are iron chlorides or copper chlorides that have a high electron affinity, the intercalates function as acceptors that introduce holes to the graphite intercalation compounds 10. Also, when the intercalates inserted inside graphite are lithium, potassium, or cesium whose ionization potential is smaller than that of the graphite, the intercalates function as donors that donate electrons to the graphite intercalation compounds 10.

The graphite oxides 20 is a type of graphite intercalation compounds obtained by oxidizing graphite by a specific method. The graphite oxides 20 have a multi-layered structure where two-dimensional base layers are stacked on one another, and the number of the layers is extremely large in general. The base layers of the graphite oxides 20 have a structure that has a carbon skeleton mainly with sp3 bonding with a tendency of sp2 bonding having a thickness of one of two carbon atoms when counted based on zigzag chains of carbon and that has acidic hydroxyl groups bonded on a surface of each side of the skeleton. As such graphite oxides 20, particles of the graphite oxides 20 also including those that are produced to have a small number of layers and are extremely thin can be obtained by oxidizing graphite.

For graphite used as a material for the particles of the graphite oxides 20, a variety of graphite can be used. However, graphite having high crystallinity with a developed layered structure is preferable for the reason that such graphite allows for the manufacturing of graphite oxides in a high yield and allows graphite oxides having less number of base layers to be easily obtained. As such graphite, natural graphite (particularly those with high quality), kish graphite (particularly those made under high temperature), and high orientation pyrolytic graphite are preferably used. In addition, expanded graphite where a space between layers of these kinds of graphite is widened in advance is also used preferably. Also, impurities such as metal elements and the like in graphite are desirably removed in advance to the point where the impurities are present in 0.5 percent by mass or below.

In order to efficiently reduce the graphite oxides 20, a reducing agent may be mixed in the conductive coating composition 100. For the reducing agent, for example, hydroquinone, resorcinol, catechol, pyrogallol, gallic acid, L-cysteine, hydriodic acid, hydrazine, phosphinic acid, citric acid, sodium thiosulfate, ammonium thiosulfate, sodium hypophosphite, polyacrylic acid, L(+)ascorbic acid, or the like is used. In particular, hydroquinone, pyrogallol, and phosphinic acid are preferable since higher conductivity can be obtained.

For the binder, a polyester resin, a vinyl resin, a phenol resin, an acrylic resin, an epoxy resin, a polyimide based resin, cellulose, etc. are used. The binder is not limited to these materials.

The dissolving agent is also referred to as solvent. As the solvent, 50 percent by mass or higher of a solvent having a boiling point of 150 degrees Celsius or higher, particularly, a solvent having a boiling point of 200 degrees Celsius or higher is preferably included. As described, by including a lot of solvent having a high boiling point, the dispersibility of carbons and inorganic substances can be easily ensured, and a smooth film can be obtained. Also, as the solvent, a solvent that has a high affinity for inorganic substances (metals, etc.) and that dissolves an additive that is described later is preferably used, and, in general, an organic solvent that has an alcoholic OH group is preferably used.

Examples of the organic solvent include alcohols and the like. For example, the alcohols are: non-aliphatic alcohols such as α-terpineol and the like; glycols such as butyl carbitol (diethylene glycol monobutyl ether), hexylene glycol (2-methyl-2,4-pentanediol), ethylene glycol-2-ethylhexyl ether, and the like; and so on. Alternatively, the organic solvent is preferably selected from N-methylpyrrolidone, dimethylformamide, dimethyl sulfoxide, cyclohexane, and the like in accordance with the affinity for carbons and the graphite oxides 20.

In the case of manufacturing an electrode by forming a dried material on a substrate from a paste-like conductive coating composition 100 by a squeegee method, all the previously-described alcohols can be used for the organic solvent. On the other hand, in the case of manufacturing an electrode by forming a dried material on a substrate from a paste-like conductive coating composition 100 by screen printing, the viscosity of the organic solvent needs to be increased, and a homogeneous coating film needs to be obtained. Therefore, as the organic solvent, α-terpineol, butyl carbitol, or the like is often used. Alternatively, in the case of performing spin coating, dip coating, spray coating, etc., a solvent with low viscosity such as aliphatic alcohol, ketones, and the like may be used, and ethanol, 2-propanol, methyl ethyl ketone, methyl isobutyl ketone, or the like may be also used. Also, a mixture of a solvent having a high boiling point and a solvent having a low boiling point may be used as the solvent. In that case, the ratio of the respective contained amounts is not particularly limited. However, as described previously, the amount of the solvent having a high boiling point is preferably 50 percent by mass or higher.

The graphite intercalation compounds 10 and the graphite oxides 20 are chemically bonded. Explaining more specifically, the graphite intercalation compounds 10 and the graphite oxides 20 are covalently or ionically bonded. Further, the volume of the graphite intercalation compounds 10 in the conductive coating composition 100 is larger than the volume of the graphite oxides 20 in the conductive coating composition 100. For example, the volume of the graphite intercalation compounds 10 in the conductive coating composition 100 is 35 percent, and the volume of the graphite oxides 20 in the conductive coating composition 100 is 15 percent. Also in a conductive material formed of graphite intercalation compounds 10 and metal particles 20, the volume of the graphite intercalation compounds 10 is larger than the volume of the graphite oxides 20 in the conductive material. For example, the volume of the graphite intercalation compounds 10 in the conductive material is 70 percent, and the volume of the graphite oxides 20 in the conductive material is 30 percent.

An explanation will be now given regarding an example of a method for manufacturing the conductive coating composition 100 and the conductive material according to the present embodiment. (1) First, the graphite intercalation compounds 10 are produced. In order for this, a graphite material used as a raw material for the graphite intercalation compounds 10 is prepared. This graphite material has a layered structure formed by a laminate of graphene. Then, a chemical species serving as an intercalate is inserted between layers of the graphite material. The chemical species to be inserted is formed of the previously-described materials. In order to insert the chemical species into the graphite material, publicly-known technology, for example, a gas phase method or a liquid phase method is used. In the gas phase method, the vapor of the chemical species is brought into contact with graphite, which is a host, under high temperature. In the liquid phase method, graphite, which is the host, is immersed in a solution where the chemical species is dissolved in the organic solvent or a liquid obtained by melting the chemical species at high temperature.

The particles of the graphite oxides 20 can be obtained by oxidizing graphite by publicly-known Brodie method, Staudenmaier method, Hummers-Offeman method, or the like. The Brodie method is a method for oxidizing graphite using nitric acid and potassium chlorate, and the Staudenmaier method is a method for oxidizing graphite using nitric acid, sulfuric acid, and potassium chlorate. The Hummers-Offeman method is a method for oxidizing graphite using sulfuric acid, sodium nitrate, and potassium permanganate.

(2) The conductive material, which is a mixture, is then produced by mixing the graphite intercalation compounds 10 and the graphite oxides 20. A ball mill, a three-roll mill, an extruder, a Banbury mixer, a V blender, a kneader, a ribbon mixer, a Henschel mixer, or the like is used at that time for uniform mixing. The production of the conductive material is not limited to these processes.

(3) By heating the conductive material, the graphite oxides 20 are reduced. The atmosphere for the reduction is not particularly limited to an air atmosphere, a nitrogen atmosphere, a hydrogen atmosphere, or the like. However, considering the safety, heating under a mixed gas atmosphere of 4 percent hydrogen and 96 percent nitrogen is preferable since the reduction is more likely to progress.

(4) A binder and a dissolving agent are added to a container having an agitator and a heating device, and a binder solution is produced while carrying out agitation and heating.

(5) By adding the conductive material, in which the graphite oxides 20 have been reduced, in the binder solution and then carrying out mixing and kneading, the conductive material is dispersed in the binder solution so as to manufacture the conductive coating composition 100. Further, by burning the conductive coating composition 100, a conductive wire may be manufactured.

An explanation will now be given regarding an exemplary embodiment according to the present embodiment. Into a glass ampule, 0.06 g of natural graphite manufactured by I to Graphite Co., Ltd., having an average particle size of 10 μm, which serves as graphite, 0.26 g of potassium chloride, and 0.6 g of anhydrous copper (II) chloride were vacuum-encapsulated, and the ampule was processed with heat for ten hours at 400 degrees Celsius. After natural cooling, the graphite was taken out from the ampule, and, by removing potassium chloride and copper (II) chloride attached on the surface thereof by washing with water, graphite intercalation compounds 10 were obtained.

Also, oxidation treatment was performed on 0.06 g of the natural graphite manufactured by I to Graphite Co., Ltd., having an average particle size of 10 μm, which serves as the graphite, by the Brodie method, and graphite oxides 20 whose moisture content had been evaporated through vacuum drying were obtained.

The graphite intercalation compounds 10 and the graphite oxides 20 were mixed in a 1:1 ratio so as to obtain a conductive material, which was a composite material of the graphite intercalation compounds 10 and the graphite oxides 20. Further, the conductive material was heated under a temperature of 200 degrees Celsius while being applied a pressure of 5 Pa, a green compact of the conductive material in which the graphite oxides 20 had been reduced was obtained.

According to the embodiment of the present invention, since the graphite intercalation compounds and the graphite oxides are chemically bonded, conductive paths can be formed. Further, since the conductive paths are formed, the conductivity can be improved. Also, since the graphite intercalation compounds are connected to one another by the graphite oxides, the bond resistance can be reduced. Further, since the graphite intercalation compounds are used, an increase in the unit price can be prevented. Also, since the surfaces of the graphite intercalation compounds are oxidized, the graphite oxides can be bonded. Further, since metal chlorides are intercalated in the graphite intercalation compounds, the conductivity can be improved. Also, since the graphite intercalation compounds and the metal particles are covalently or ionically bonded to each other, the conductivity can be improved.

Further, since the volume of the graphite intercalation compounds is larger than the volume of the graphite oxides in the conductive coating composition, the graphite intercalation compounds are connected to one another by the graphite oxides. Also, since the reducing agent is included, the graphite intercalation compounds and the graphite oxides can be bonded. Further, since the volume of the graphite intercalation compounds is larger than the volume of the graphite oxides in the conductive material, the graphite intercalation compounds are connected to one another by the graphite oxides. Also, since low cost and highly conductive graphite intercalation compounds are used for a wiring material for which an expensive metal material is conventionally used, the cost can be lowered while keeping high conduction characteristics. Further, since the graphite intercalation compounds are bonded to one another using the graphite oxides, high conductivity that cannot be achieved by conventional carbon-based wires can be achieved.

A brief description of the present embodiment is as shown in the following. A conductive coating composition 100 according to one embodiment of the present invention includes graphite intercalation compounds 10, graphite oxides 20, a binder, and a dissolving agent, and the graphite intercalation compounds 10 and the graphite oxides 20 are chemically bonded.

The surfaces of the graphite intercalation compounds 10 may be oxidized.

Metal chlorides may be intercalated in the graphite intercalation compounds 10.

The graphite intercalation compounds 10 and the graphite oxides 20 may be covalently or ionically bonded.

The volume of the graphite intercalation compounds 10 in the conductive coating composition 100 is larger than the volume of the graphite oxides 20 in the conductive coating composition 100.

A reducing agent may be further included.

Another embodiment of the present invention relates to a conductive material. The conductive material includes graphite intercalation compounds 10 and graphite oxides 20, and the graphite intercalation compounds 10 and the graphite oxides 20 are chemically bonded.

Yet another embodiment of the present invention relates to a method for manufacturing a conductive coating composition 100. This method is a method for manufacturing a conductive coating composition 100, including: producing a conductive material by mixing graphite intercalation compounds 10 and graphite oxides 20; reducing the graphite oxides 20 by heating the conductive material; producing a binder solution while agitating and heating a binder and a dissolving agent; and adding the conductive material, in which the graphite oxides 20 have been reduced, in the binder solution, wherein the graphite intercalation compounds 10 and the graphite oxides 20 are chemically bonded.

Yet another embodiment of the present invention relates to a method for manufacturing a conductive material. This is a method for manufacturing a conductive material in which graphite intercalation compounds 10 and graphite oxides 20 are mixed, and the graphite intercalation compounds 10 and the graphite oxides 20 are chemically bonded.

Described above is an explanation of the present invention based on the embodiments. These embodiments are intended to be illustrative only, and it will be obvious to those skilled in the art that various modifications to combinations of constituting elements could be developed and that such modifications are also within the scope of the present invention.

### DESCRIPTION OF THE REFERENCE NUMERALS

10 graphite intercalation compound, 20graphite oxide, 100 conductive coating composition

### INDUSTRIAL APPLICABILITY

According to the present invention, conductivity can be improved while preventing an increase in unit price.

1. A conductive coating composition comprising: graphite intercalation compounds; graphite oxides; a binder; and a dissolving agent,
wherein the graphite intercalation compounds and the graphite oxides are chemically bonded.

2. The conductive coating composition according to claim 1, wherein the surfaces of the graphite intercalation compounds are oxidized.

3. The conductive coating composition according to claim 1, wherein metal chlorides are intercalated in the graphite intercalation compounds.

4. The conductive coating composition according to claim 1, wherein the graphite intercalation compounds and the graphite oxides are covalently or ionically bonded.

5. The conductive coating composition according to claim 1, wherein the volume of the graphite intercalation compounds in the conductive coating composition is larger than the volume of the graphite oxides in the conductive coating composition.

6. The conductive coating composition according to claim 1, further comprising a reducing agent.

7. A conductive material comprising: graphite intercalation compounds; and graphite oxides,
wherein the graphite intercalation compounds and the graphite oxides are chemically bonded.

8. A method for manufacturing a conductive coating composition, comprising:
producing a conductive material by mixing graphite intercalation compounds and graphite oxides;
reducing the graphite oxides by heating the conductive material;
producing a binder solution while agitating and heating a binder and a dissolving agent; and
adding the conductive material, in which the graphite oxides have been reduced, in the binder solution,
wherein the graphite intercalation compounds and the graphite oxides are chemically bonded.

9. A method for manufacturing a conductive material in which graphite intercalation compounds and graphite oxides are mixed,
wherein the graphite intercalation compounds and the graphite oxides are chemically bonded.
